(19) United States
(12) Patent Application Publication
(10) Pub. No.: US 2026/0361438 A1
(43) Pub. Date: Nov. 12, 2026

(54) AI/ML Beam Prediction Monitoring in Wireless Networks Based on Spectral Entropy for CSI Compression

(71) Applicant: Apple Inc., Cupertino, CA (US)

(72) Inventors: Konstantinos Sarrigeorgidis, Los Gatos, CA (US); Wanshi Chen, San Diego, CA (US); Yang Tang, San Jose, CA (US)

(21) Appl. No.: 19/670,321

(22) Filed: May 7, 2026

(30) Foreign Application Priority Data
May 9, 2025 (GR) 20250100348

(51) Int. Cl. H04B 17/391; H04B 7/06; H04L 5/00; H04L 25/02; H04W 24/10

(52) U.S. Cl. CPC H04B 17/3913; H04B 7/0626; H04L 5/0048; H04L 25/022; H04W 24/10

(57) ABSTRACT

Systems and methods are for receiving a reference signal for channel state information (CSI) including CSI samples; determining, from the reference signal, a value of a performance metric representing a distribution of the CSI samples in a spatial domain; and causing transmission of a report including the value of the performance metric.

### CLAIM OF PRIORITY

This application claims priority to Greek Patent Application Serial No. 20250100349, filed on May 9, 2025, the entire contents of which are hereby incorporated by reference.

### TECHNICAL FIELD

This application relates to wireless communication networks.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using one or more wireless network protocols, such as protocols described in various telecommunication standards promulgated by the ETSI Third Generation Partnership Project (3GPP). The wireless communication networks facilitate mobile broadband service using technologies such as orthogonal frequency-division multiple access (OFDMA), multiple input multiple output (MIMO), advanced channel coding, massive MIMO, beamforming, and/or other features.

### SUMMARY

In an aspect, a method includes receiving a reference signal for channel state information (CSI) including CSI samples; determining, from the reference signal, a value of a performance metric representing a distribution of the CSI samples in a spatial domain; and causing transmission of a report including the value of the performance metric.

In some implementations, including one or more of the other implementations described herein, determining the value of the performance metric comprises: determining a frequency response of a channel across a sub-carrier domain and a spatial transmitter port; transforming the frequency response into an angular and temporal delay domain matrix resolvable angular paths and delay paths; determining, from the angular and temporal delay domain matrix, a normalized power profile; and determining the value of the performance metric as a sum of the normalized power profile for each of the angular paths and the delay paths.

In some implementations, including one or more of the other implementations described herein, the method includes causing one or more life cycle management (LCM) operations to occur independent of measuring a CSI ground truth value.

In some implementations, including one or more of the other implementations described herein, the method includes updating an AI/ML model configured to predict a beam based on the determined value of the performance metric.

In some implementations, including one or more of the other implementations described herein, the method includes discarding an AI/ML model configured to predict a beam based on the determined value of the performance metric; measuring one or more CSI ground truth values; and causing one or more life cycle management (LCM) operations to occur based on measuring the one or more CSI ground truth values.

In some implementations, including one or more of the other implementations described herein, the value of a performance metric representing a distribution of the CSI samples in a spatial domain indicates that the CSI samples are more distributed in a spatial-frequency domain when the value is high and less distributed in the spatial-frequency domain when the value is low.

In some implementations, including one or more of the other implementations described herein, the method includes detecting, based on the value of the performance metric, a drift in an AI/ML model configured to predict beam values.

In some implementations, including one or more of the other implementations described herein, the method includes determining values of the performance metric over time including the value of the performance metric; and based on detecting one or more of a trend in the values of the performance metric over time or a sudden change between at least two values of the performance metric over time, causing a life cycle management (LCM) operation to occur.

In some implementations, including one or more of the other implementations described herein, determining values of the performance metric over time comprises determining two values of the performance metric.

In some implementations, including one or more of the other implementations described herein, determining values of the performance metric over time comprises determining a set of the performance metric values and reducing a weighting associated with an older value of the performance metric.

In some implementations, including one or more of the other implementations described herein, the method includes applying a regression model or a classifier model to detect the trend in the values of the performance metric over time or the sudden change between at least two values of the performance metric over time.

In some implementations, including one or more of the other implementations described herein, the method includes, based on the value of the performance metric, causing at least one of: initiating inference monitoring with KPIs requiring ground truth measurements, deactivation of an AI/ML model that predicts beams, switching to another AI/ML model that predicts beams, initiating retraining procedures for an AI/ML model based on current channel conditions, or reconfiguring parameters of an AI/ML model.

In an aspect, a method includes sending a reference signal for channel state information (CSI) including CSI samples; and receiving, after sending the reference signal, a report including a value of a performance metric representing a distribution of the CSI samples in a spatial domain.

In some implementations, including one or more of the other implementations described herein, the value of the performance metric is determined by: determining a frequency response of a channel across a sub-carrier domain and a spatial transmitter port; transforming the frequency response into an angular and temporal delay domain matrix resolvable angular paths and delay paths; determining, from the angular and temporal delay domain matrix, a normalized power profile; and determining the value of the performance metric as a sum of the normalized power profile for each of the angular paths and the delay paths.

In some implementations, including one or more of the other implementations described herein, the method includes causing one or more life cycle management (LCM) operations to occur independent of measuring a CSI ground truth value.

In some implementations, including one or more of the other implementations described herein, the method includes causing an update to an AI/ML model configured to predict a beam based on the value of the performance metric.

In some implementations, including one or more of the other implementations described herein, the method includes causing an AI/ML model, which is configured to predict a beam, to be discarded based on the value of the performance metric.

In some implementations, including one or more of the other implementations described herein, the value of a performance metric representing a distribution of the CSI samples in a spatial domain indicates that the CSI samples are more distributed in a spatial-frequency domain when the value is high and less distributed in the spatial-frequency domain when the value is low.

In some implementations, including one or more of the other implementations described herein, the method includes detecting, based on the value of the performance metric, a drift in an AI/ML model configured to predict beam values.

In some implementations, including one or more of the other implementations described herein, the method includes determining values of the performance metric over time including the value of the performance metric; and based on detecting one or more of a trend in the values of the performance metric over time or a sudden change between at least two values of the performance metric over time, causing a life cycle management (LCM) operation to occur.

In some implementations, including one or more of the other implementations described herein, determining values of the performance metric over time comprises determining two values of the performance metric.

In some implementations, including one or more of the other implementations described herein, determining values of the performance metric over time comprises determining a set of the performance metric values and reducing a weighting associated with an older value of the performance metric.

In some implementations, including one or more of the other implementations described herein, the method includes applying a regression model or a classifier model to detect the trend in the values of the performance metric over time or the sudden change between at least two values of the performance metric over time.

In some implementations, including one or more of the other implementations described herein, the method includes, based on the value of the performance metric, causing at least one of: initiating inference monitoring with KPIs requiring ground truth measurements, deactivation of an AI/ML model that predicts beams, switching to another AI/ML model that predicts beams, initiating retraining procedures for an AI/MBL model based on current channel conditions, or reconfiguring parameters of an AI/IL model.

In an aspect, one or more processors are configured to, when executing instructions stored in memory, perform any of the foregoing methods.

In an aspect, a non-transitory computer storage medium is encoded with instructions that, when executed by one or more processors, cause the one or more processors to perform any of the foregoing methods.

In an aspect, a system comprises one or more processors and one or more storage devices on which are stored instructions that are operable, when executed by the one or more processors, to cause the one or more processors to perform any of the foregoing methods.

In an aspect, an apparatus comprising one or more baseband processors is configured to perform any of the foregoing methods.

In an aspect, a base station comprises one or more processors configured to perform any of the foregoing methods.

The details of one or more embodiments of these systems and processes are set forth in the accompanying drawings and the description below. Other features, objects, and advantages of these systems and processes will be apparent from the description and drawings, and from the claims.

### BRIEF DESCRIPTION OF THE FIGURES

FIG. 1 illustrates an example wireless network.

FIG. 2A is a diagram that illustrates an example of spatial-domain downlink beam prediction, according to some implementations.

FIG. 2B is a diagram that illustrates an example of time-domain downlink beam prediction, according to some implementations.

FIG. 3A illustrates an example process of artificial intelligence and machine learning (AI/ML)-based downlink beam management based on beam prediction at a base station.

FIG. 3B illustrates an example process of AI/ML-based downlink beam management based on beam prediction at a user equipment (UE).

FIG. 4 illustrates an example system for performance monitoring using an Angular Delay Spectral Entropy (ADSE) metric.

FIG. 5A illustrates an example process for performance monitoring using an ADSE metric.

FIG. 5B illustrates an example process for performance monitoring using an ADSE metric.

FIG. 6 illustrates an example user equipment (UE).

FIG. 7 illustrates an example access node.

### DETAILED DESCRIPTION

Wireless communication networks can support multi-beam operation and beamforming techniques to achieve a higher data rate. Beam management can facilitate alignment of a pair of transmit and receive beams. For example, during a downlink beam management procedure, a user equipment (UE) measures a reference signal (e.g., synchronization signal block SSB, channel state information reference signal CSI-RS) associated with transmit beams from a base station and selects a suitable receive beam that is best aligned with the transmit beam. To enhance this beam management functionality, artificial intelligence and machine learning (AI/ML) models and techniques can be used for beam prediction, including predictions in the spatial-domain or the time-domain. Spatial-domain downlink beam prediction (e.g., referred to as BM-Case 1) uses measurements of a configured set of downlink beams (e.g., denoted as Set B) to predict the best beam within another set of downlink beams (e.g., denoted as Set A) at present. Time-domain downlink beam prediction (e.g., referred to as BM-Case 2) uses measurements of Set B to predict the best beam within Set A on future prediction instances.

An inference performance of the AI/ML model affects an accuracy of beam selection by a UE, such as during beam management. Performance monitoring can ensure that the AI/ML model output results in optimal beam management. For example, the AI/ML model can assist a UE in selection/scheduling of beams to allow an increased total data rate or other optimized performance. Performance monitoring may be performed at a network (e.g., base station) and/or assisted by the UE. For example, for UE-assisted performance monitoring, the UE calculates and reports to the network a performance metric (e.g., beam prediction accuracy). Based on the reported performance metric, the network can determine how to use the AI/ML model output. The network or UE, for example, may determine that the UE should continue using the AI/ML model or to switch back to the legacy beam management operation.

Monitoring of AI/ML functionality by post-deployment testing can be one way to manage post-deployment performance through life cycle management (LCM). Post-deployment testing includes monitoring AI/ML models and potentially updating the AI/ML models used for beam prediction. The network can ensure that deployed models perform similarly to models passing conformance testing, such as when the deployed models are updated or after a time period has passed.

However, the network cannot re-apply conformance testing to UEs that are already in use because these UEs are not available for testing. The network should determine whether the AI/ML model performance has degraded after a model update has occurred. The network can perform post-deployment testing based on one of the following. In a first option, the network performs pre-activation functionality/model update testing. The network performs testing of a functionality/model prior to the actual use in a UE. The testing can include testing of equivalent hardware in a lab, by simulation, or within the actual UE. In another option, the network can perform post deployment management based on LCM. The network does not perform direct testing but relies on performance monitoring of the UE.

Performance monitoring of AI/ML models in UEs can be challenging in a complex environment. The robustness of performance monitoring should be kept above a particular standard regardless of the UE conditions. This is because a large number of factors may influence a behavior of a link for CSI, including changing channel conditions, changing user conditions (e.g., Doppler effects, etc.), various antenna port layouts (e.g., N1/N2/P), and/or antenna port numbers (e.g., 32 ports, 16 ports, etc.), various antenna virtualizations (TxRU mapping), and various outdoor/indoor UE distributions for 3D-urban micro (UMi) and 3D-urban macro (UMa) channel models.

The following metrics/methods for AI/ML model monitoring in lifecycle management per use case are considered. In a first example, monitoring is based on inference accuracy, including metrics related to intermediate KPIs. In a second example, monitoring is based on system performance, including metrics related to system performance KPIs. In another example, monitoring solutions include one or more of monitoring based on data distribution or applicable network conditions. The monitoring can be input-based including monitoring a validity of the AI/ML input for out-of-distribution detection, drift detection of input data or SNR, delay spread, and so forth. In another example, the monitoring can be output based, such as for drift detection of output data.

Monitoring metric calculation may be done by the network or the UE, as previously described. For network-side monitoring, the network may calculate the intermediate KPI between the ground-truth CSI (e.g., target CSI with realistic channel estimation) reported by UE and the recovery CSI. As the accuracy of measured ground-truth CSI is testable at RAN4, the reliability of the monitored results can be guaranteed regardless of the change of environment. For the reporting format, eT2-like high-resolution codebook may be used because it can have better monitoring performance. By using eT2-like high-resolution codebook rather than a legacy eT2 codebook, the ground-truth CSI is reported more precisely. However, a relatively high signaling overhead can result. For the reporting mode, both per sample reporting and reporting of a number of monitored samples can be considered. In particular, for the type of intermediate KPI, the preference between a Spectral Gain Channel Steering (SGCS) KPI and Normalized Mean Square Error (NMSE) KPI may be related to the input type between the precoding matrix and the channel matrix.

To overcome these issues of complexity in reporting, an input data distribution KPI can include Angular Delay Spectral Entropy (ADSE). The ADSE metric can account for changing UE conditions reduce a complexity of reporting key performance indicators (KPIs) for performance monitoring by reducing an amount and/or variation of data to be reported to the network. The simplification of the performance monitoring information (KPIs) to be reported while accounting for environment complexity can reduce signaling overhead and bandwidth usage for performance monitoring without reducing a utility of the reported information. The ADSE can be based on the CSI-RS input for determining whether the AI/ML model is valid or not.

The ADSE represents an entropy of the channel, or a measure of uncertainty in the channel, as subsequently described. When there are greater delays and angular variation or spread in the channel, the entropy is greater. This contrasts with a narrow spread or few delays, with a lower entropy. The entropy represents how compressible the channel estimation is. For higher entropy, the channel estimation is not as compressible as it is for lower entropy. If an AI/ML model is trained with a particular input CSI, the CSI distributions translates to a particular entropy. If the model is trained with low entropy channels, and the entropy in the channel becomes high, the model output may not be accurate, and the AI/ML model may not work at all. The channel has changed to now have more variation in spatial domain. CSI compression is more difficult, and the model trained on more compressible channels may be degraded. In this circumstance, the UE may send ground truth measurements for validating the AI/ML model output.

The UE can detect monitoring events without ground truth CSI and excessive overhead signaling. The UE can use an input-CSI-distribution based monitoring. This monitoring focuses on statistical or semantic properties of input CSI samples. Based on the statistical or semantic properties of the CSI samples, the UE determines the spectral entropy and signals the KPI to the network.

The network responds to the reported ADSE KPI value with LCM procedures. The network can respond based on the reported KPI or based on historical KPI trends. The ADSE value reflects that any significant change in the environment or configuration/scenario may inherently alter the statistical or semantic properties of the CSI samples. The network, by continuously monitoring how the statistical/semantic properties of the CSI samples evolve over time, can detect sudden deviations or trends. The network can react by implementing one or more post-deployment procedures, such as initiating inference monitoring with KPIs requiring ground truth measurements, signal the UE to de-activate an AI/ML model, signal the UE to switch to another AI/ML model (e.g., based on ADSE proximity), initiate retraining procedures based on current conditions, reconfigure parameters of the AI/ML model, or perform some other action. The ADSE can reduce the amount of information needed by the UE to represent the channel and execute AI/ML model performance monitoring.

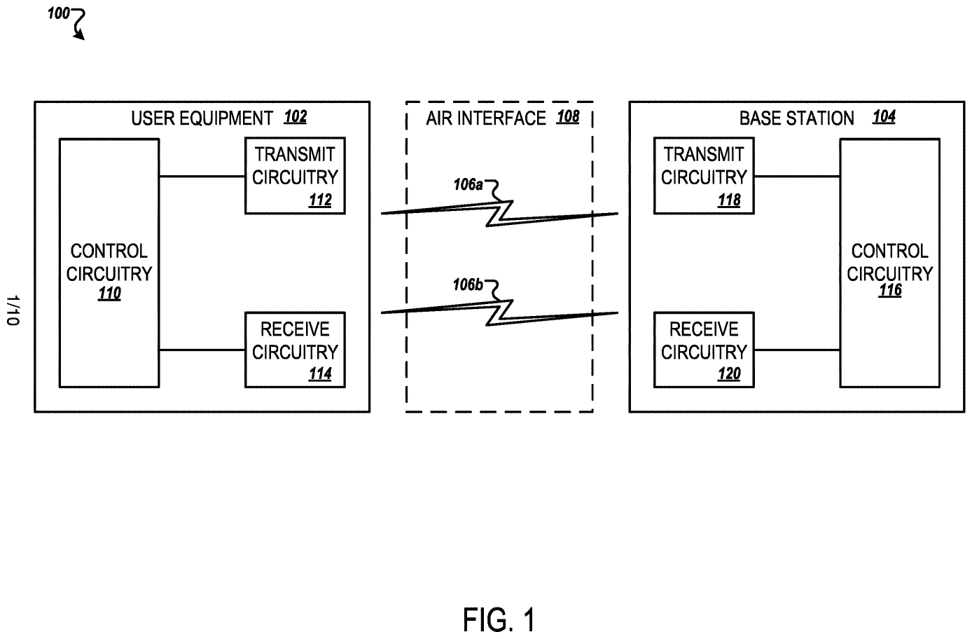

FIG. 1 illustrates a wireless network 100. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 is a Standalone (SA) network, e.g., that incorporates Fifth Generation (5G) New Radio (NR). In some other implementations, the wireless network 100 is a Non-Standalone (NSA) network that incorporates Long Term Evolution (LTE) and 5G NR. In these implementations, the wireless network 100 may be a E-UTRA (Evolved Universal Terrestrial Radio Access)-NR Dual Connectivity (EN-DC) network, or an NR-EUTRA Dual Connectivity (NE-DC) network. Furthermore, wireless networks implementing one or more other types of communication standards are possible, including future 3GPP systems (e.g., Sixth Generation (6G)), Institute of Electrical and Electronics Engineers (IEEE) 802.11 technology, or the like. While aspects may be described herein using terminology commonly associated with 5G NR, aspects of the present disclosure can be applied to other systems, such as systems subsequent to 5G (e.g., 6G).

In the wireless network 100, the UE 102 and any other UE in the system may be, for example, any of a laptop computer, smartphone, tablet computer, machine-type device (such as smart meters or specialized devices for healthcare), intelligent transportation system, or any other wireless device. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include application-specific circuitry, baseband circuitry, or any of various combinations thereof. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and/or control circuitry 110 may be integrated in various ways to implement the operations described herein. The control circuitry 110 may be adapted or configured to perform various operations, such as those described elsewhere in this disclosure related to a UE.

The transmit circuitry 112 may transmit using a plurality of multiplexed uplink physical channels. The plurality of uplink physical channels may be multiplexed, e.g., according to time division multiplexing (TDM) or frequency division multiplexing (FDM), and in some implementations, along with carrier aggregation. The transmit circuitry 112 may be configured to receive block data from the control circuitry 110 for transmission on the air interface 108.

The receive circuitry 114 may receive a plurality of multiplexed downlink physical channels from the air interface 108 and relay the physical channels to the control circuitry 110. The plurality of downlink physical channels may be multiplexed, e.g., according to TDM or FDM, e.g., along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell, or a legacy RAN, such as a UTRAN. As used herein, the term “5G RAN” or the like may refer to the base station 104 that operates in an NR wireless network 100, and the term “E-UTRAN” or the like may refer to a base station 104 that operates in an LTE wireless network 100. The UE 102 utilizes connections (or channels) 106A, 106B, each of which includes a physical communications interface or layer.

The base station 104 circuitry may include control circuitry 116 coupled (directly or indirectly) with transmit circuitry 118 and/or receive circuitry 120. The transmit circuitry 118 and receive circuitry 120 may each be coupled (directly or indirectly) with one or more antennas that may be used to enable communications via the air interface 108. The transmit circuitry 118 and receive circuitry 120 may be adapted to transmit and receive data, respectively, addressed to any UE connected to the base station 104. The receive circuitry 120 may receive a plurality of uplink physical channels from one or more UEs, including the UE 102.

In FIG. 1, the one or more channels 106A, 106B are illustrated as an air interface 108 to enable communicative coupling, and can be consistent with cellular communications protocols, such as an LTE protocol, Advanced LTE (LTE-A) protocol, LTE-based access to unlicensed spectrum (LTE-U), NR protocol, NR-based access to unlicensed spectrum (NR-U) protocol, and/or any other communications protocol(s). In some implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

The UE 102 and the base station 104 are configured to perform operations assisted based on AI/ML models for wireless communication. For example, AI/ML models and AI/ML techniques may be used for channel state information (CSI) feedback, beam management, and/or positioning. The AI/ML techniques may also enable network automation or data collection for various network functions. Furthermore, the AI/ML techniques may support AI/ML-based network energy savings, load balancing, and mobility optimization.

The AI/ML model may be defined as a data-driven algorithm that applies AI/ML techniques to generate a set of outputs based on a set of inputs. The AI/ML model may be implemented at the UE side, the network side, or both. Generally, stages of AI/ML-related algorithms and associated complexity may be characterized by model generation and inference operation (e.g., input/output, pre-/post-process). The model generation may include model training (e.g., input/output, pre-/post-process, online/offline), model validation, and model testing. The life cycle management (LCM) of AI/Model and AI/ML functionality may be implemented for various aspects, which include, for example, data collection, model training, functionality/model identification, model delivery/transfer, model inference operation, functionality/model selection, activation, deactivation, switching and fallback operation, functionality/model monitoring, model update, and UE capability.

For AI/ML-based beam management, various AI/ML techniques, such as at least model training, model inference, and model monitoring, may be used. For AI/ML model training, the UE or the base station may generate training data. The AI/ML model training described herein is a process to train an AI/ML model in a data-driven manner and obtain the trained AI/ML model for inference of network conditions in the future. The AI/ML model inference described herein includes a process of using the trained AI/ML model to produce a set of outputs based on a set of inputs. For network-side AI/ML model inference, the UE may generate input data and transmit the generated input data to the base station. For UE-side AI/ML model inference, input data may be internally available at the UE. In order to evaluate the inference performance of the AI/ML model, AI/ML model monitoring (e.g., performance monitoring) may be performed.

Performance monitoring for an AI/ML model ensures the proper operation of such a model. Among various types of performance monitoring, Type 1 can be supported for both BM-Case 1 and BM-Case 2. For Type 1 performance monitoring, the UE may be configured or signaled from a network, such as the base station, for measurement and/or reporting. The UE may support two options of Type 1 performance monitoring: Option 1 is network-side performance monitoring, and Option 2 is UE-assisted performance monitoring. During Type1/Option1 network-side performance monitoring, the UE may transmit a monitoring result report to the network (e.g., for the calculation of a performance metric at the network). The monitoring result report may include measurement results from resource sets for performance monitoring (e.g., L1-RSRP and/or RS index) and any other contents. During Type1/Option2 performance monitoring, the UE may calculate one or more performance metrics and report them or associated information to the network. Performance metrics described herein can be a beam prediction accuracy (e.g., Top-K/1 beam prediction accuracy).

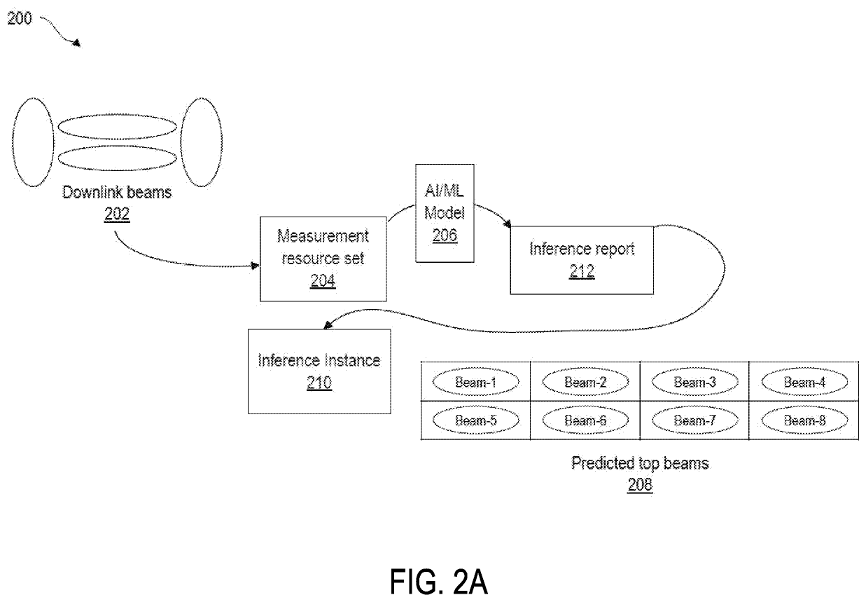

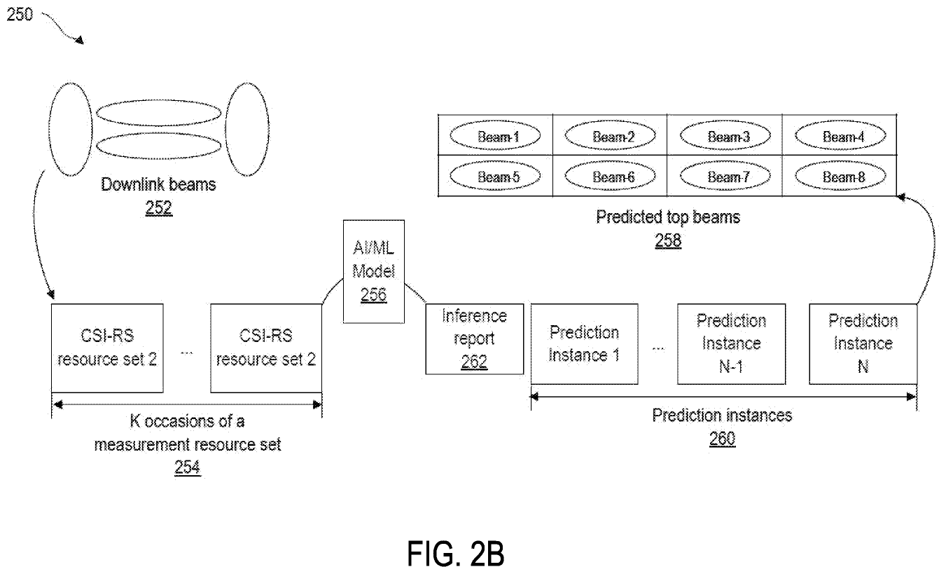

FIG. 2A illustrates an example diagram 200 of spatial-domain downlink beam prediction, according to some implementations. Spatial-domain downlink beam prediction may be performed at a UE (e.g., UE 102) or a base station (e.g., base station 104) based on measurement results of Set B of beams to predict the best beams within Set A of beams. The UE performs measurements of downlink beams 202 (e.g., Set B) on measurement resource set 204 (e.g., SSB, CSI-RS resource set) configured by the base station. Using the AI/ML model 206, the top beams 208, Beam-1 through Beam-8, may be inferred at present (or predicted for the future) at the inference instance 210 based on the measurement result of downlink beams 202. The inference report 212 may include information, such as a beam index and an L1-RSRP, of the predicted top beams 208 for the inference instance 210.

FIG. 2B illustrates an example diagram 250 of time-domain downlink beam prediction, according to some implementations. Time-domain (or temporal) downlink beam prediction may be performed at a UE (e.g., UE 102) or a base station (e.g., base station 104) based on measurement results of Set B of beams to predict the best beam within Set A of beams for future time instants. The UE performs measurements for downlink beams 252 (e.g., Set B) on each of K occasions of measurement resource set 254 (e.g., SSB, CSI-RS resource set) configured by the base station. Using the AI/ML model 256, the top beams 258 can be predicted (or inferred) in each of N prediction instances 260 based on the measurement results of downlink beams 252. As such, the inference report 262 may include information, such as a beam index and an L1-RSRP, on the predicted top beams 258 for N prediction instances 260.

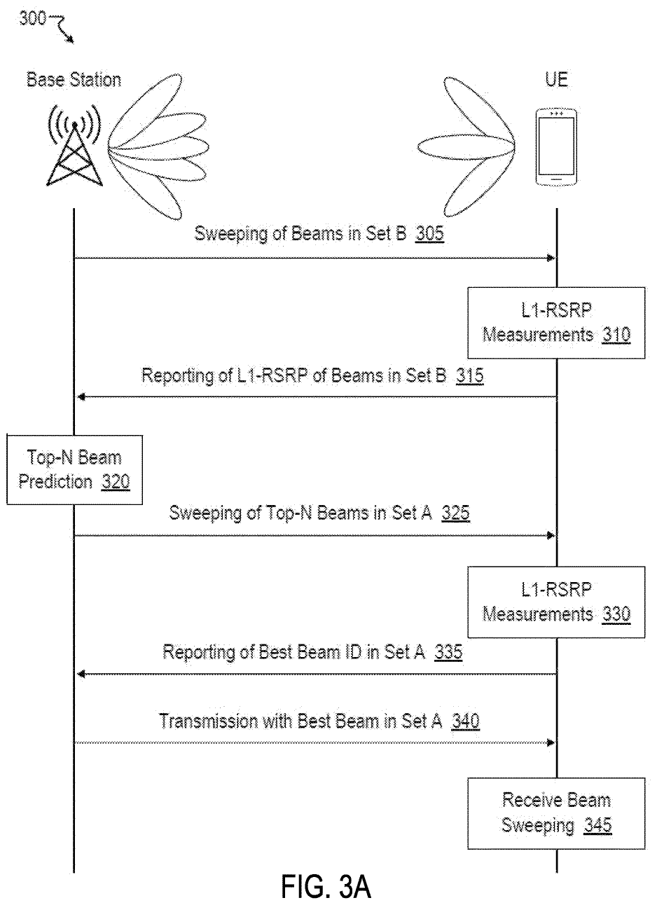

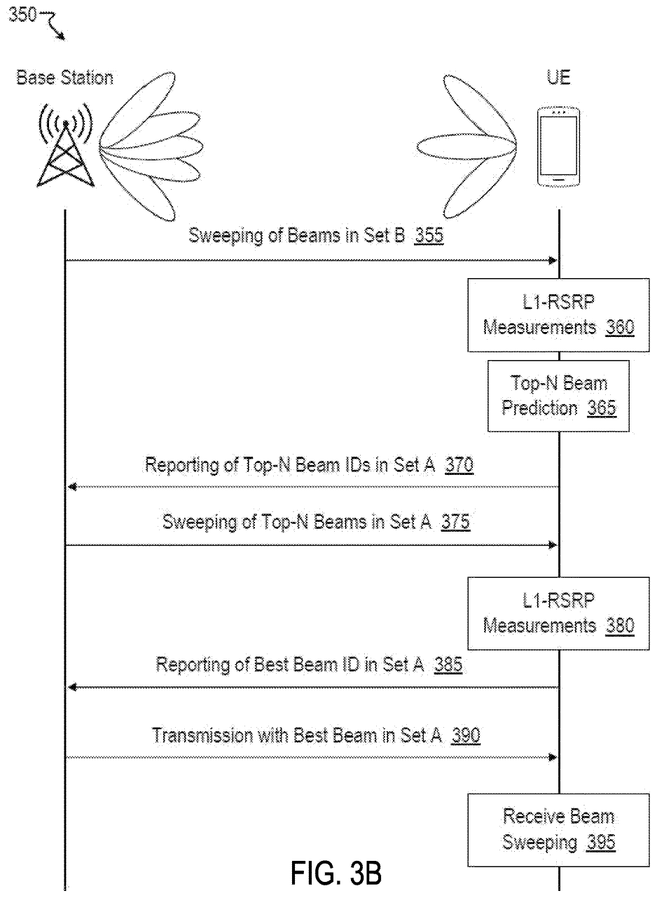

FIG. 3A illustrates an example process 300 of AI/ML-based downlink beam management based on beam prediction at a base station, according to some implementations. A UE (e.g., UE 102) and the base station (e.g., base station 104) perform a beam management process based on a beam prediction at the base station. The base station sweeps (305) through transmit beams in Set B to collect data. The UE performs (310) L1-RSRP measurements of the transmit beams in Set B. The UE reports (315) the L1-RSRP measurement of the transmit beams in Set B to the base station. The base station performs (320) beam prediction using an AI/ML model to predict top-N transmit beams in Set A. The base station sweeps (325) through the top-N transmit beams in Set A. The UE performs (330) L1-RSRP measurements of the top-N transmit beams in Set A to identify the best beam. The UE reports (335) the identity (ID) of the best transmit beam in Set A to the base station. The base station transmits (340) with the best beam in Set A. the UE sweeps (345) through different receive beams to find the best receive beam that pairs with the selected transmit beam.

FIG. 3B illustrates an example process 350 of AI/ML-based downlink beam management based on beam prediction at a UE, according to some implementations. A UE (e.g., UE 102) and the base station (e.g., base station 104) perform a beam management process based on a beam prediction at the UE. The base station sweeps (355) through transmit beams in Set B to collect data. The UE performs (360) L1-RSRP measurements of the transmit beams in Set B. The UE performs (365) beam prediction using an AI/ML model to predict top-N transmit beams in Set A. The UE reports (370) the top-N transmit beams in Set A. The base station sweeps (375) through the top-N transmit beams in Set A. The UE performs (380) L1-RSRP measurements of the top-N transmit beams in Set A to identify the best beam. The UE reports (385) the ID of the best transmit beam in Set A to the base station. The base station transmits (390) with the best beam in Set A. The UE sweeps (395) through different receive beams to find the best receive beam that pairs with the selected transmit beam.

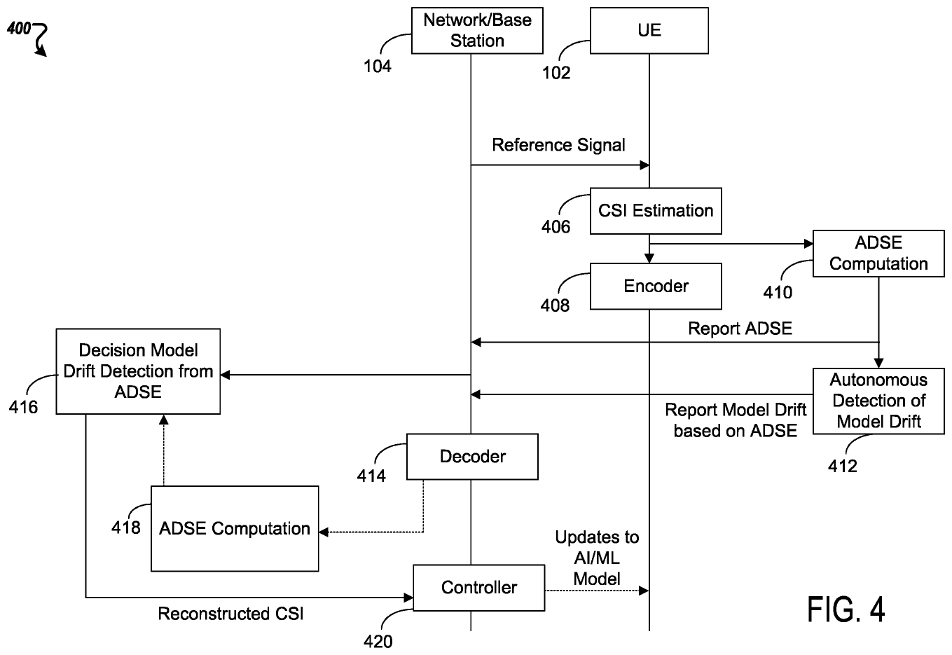

FIG. 4 illustrates an example system 400 for performance monitoring using an Angular Delay Spectral Entropy (ADSE) metric. The network/base station 104 (hereinafter network) sends a reference signal to the UE 102 (e.g., a CSI-RS) for channel estimation. The UE receives the CSI-RS and performs (406) CSI estimation and encodes information with an encoder 408.

The UE 102 performs CSI compression to reduce the amount of data needed to represent the channel. The UE 102 uses compression for high-dimensional CSI, where each signal path (or antenna port) is represented by multiple parameters (e.g., amplitude, phase, and frequency components). Efficient compression can reduce the number of bits needed to describe the channel's state without sacrificing performance. Because the AI/ML model for CSI feedback performs compression, the ADSE metric that measures the compressibility of the channel is an accurate metric to compare the similarity of the input data distributions.

ADSE measures an uncertainty in the distribution of power across the frequency and spatial components of a signal, which is directly related to a predictability (or randomness) of the channel's frequency response. When the UE 102 applies ADSE to CSI channel compression, the ADSE value can help the UE 102 determine which parts of the channel are more concentrated (low entropy) and which parts are more spread out (high entropy).

The ADSE value represents a measure of smoothness and correlation in CSI samples. In the spatial-frequency domain, smoothness or correlation in CSI samples indicates how coherent or predictable the wireless channel is across space and frequency. A low ADSE value represents a more predictable (smooth/correlated) channel, meaning power is concentrated in a smaller number of dominant components. A high ADSE value represents a less predictable (less smooth, less correlated) channel, meaning power is distributed more evenly across components.

The UE 102 can use the ADSE and sparsity in the delay-beam domain together to simplify representation of the CSI samples for performance monitoring. When transformed to the delay-beam domain, the sparsity of CSI samples reflects the channel's structure, such as multipath delays and angular spread of signals. A lower ADSE implies higher sparsity in the delay-beam domain, which simplifies the representation of CSI samples and enhances the efficiency of AI/ML-based compression methods. The wireless channel's behavior directly affects the ADSE of CSI samples.

Environmental changes such as mobility, obstructions, and interference can alter the smoothness or sparsity of the CSI samples. The UE 102 can monitor the ADSE of input CSI RSs and detect changes in the radio frequency (RF) environment in real time. The network 104 can track the ADSE value (reported by the UE 102) of recovered CSI RSs after decompression to assess a quality of the feedback and detect anomalies in the channel or compression process.

The UE 102 can determine the ADSE value at an ADSE computation 410 stage. The UE 102 can report the ADSE to the network 104. The UE 102 can perform performance management operations on the AI/ML model as previously described, such as detecting (412) AI/ML model drift autonomously and reporting the model drift to the network.

For a given MIMO channel, there are a number of transmitter (Tx) antenna ports Nₜ, and N_{c} carriers in the frequency domain, which is H̅∈C^{N}^{_{c}}^{×N}^{ₜ}, where H̅ is the channel estimation by the UE 102 from the CSI-RS. The channel estimation is in the spatial and frequency domains. C^{N}^{_{c}}^{×N}^{ₜ} represents the channel estimates for the ports Nₜ and carriers N_{c}. To derive the power profile of the channel in the angular space (e.g., spatial frequencies) and delay temporal space (e.g., frequencies), the performance monitoring system (e.g., of the UE 102) can use a two-dimensional 2D Fourier Transform (2D DFT). The 2D DFT is shown in equation (1):

$$H = {F}_{d} \tilde{H} {F}_{a}^{H} , \qquad ( 1 )$$

where F_{d} and Fₐ are N_{c}×N_{c} and Nₜ×Nₜ DFT matrices. The conversion of the channel estimates H̅∈C^{N}^{_{c}}^{×N}^{ₜ} to the power profile through 2D-DFT processing. Each entry of H represents a resolvable beam in the delay angular domain. The domain representation indicates how many different delays and how many different angular arrays there are.

The performance monitoring system (e.g., of UE 102) determines the ADSE value as follows. The performance monitoring system obtains the channel's frequency response CSI the RS. The performance monitoring system obtains the channel matrix: H̅[k][m], across a sub-carrier domain k and spatial Tx antenna port m. The performance monitoring system transforms the channel to the angular and temporal delay domain by obtaining the transformed matrix

$$H [ i ] [ j ] = {F}_{d} \tilde{H} {F}_{a}^{H} ,$$

across angular domain i and delay domain j, representing resolvable angular and delay paths. This represents the entropy of the channel, or the measure of uncertainty. The greater the delays and angular variation or spread in the channel, the greater the entropy. This contrasts with a narrow spread or few delays, with a lower entropy. The entropy represents how compressible the channel estimation matrix H̅ is.

For higher entropy, the channel estimation is not as compressible as it is for lower entropy. If an AI/ML model is trained with a particular input CSI, the CSI distributions translates to a particular entropy. If the model is trained with low entropy channels, and the entropy in the channel becomes high, the model output may not be accurate, and the AI/ML model may not work at all. The channel has changed to now have more variation in special domain. CSI compression is more difficult, and the model trained on more compressible channels may be degraded. In this circumstance, the UE 102 may send ground truth measurements for validating the AI/MWL model output.

When transformed to this delayed angle domain, the sparsity of CSI samples reflects the channel structure. When there are multiple delays and angular spread of signals in the channel there is a lower entropy, implying a greater sparsity in the CSI samples.

The performance monitoring system determines the normalized power profile (PSD) by computing a normalized power profile based on equation (2):

$$P [ i ] [ j ] = \frac{{\vert H [ i ] [ j ] \vert}^{2}}{{\sum }_{i} {\sum }_{j} {\vert H [ i ] [ j ] \vert}^{2}} \qquad ( 2 )$$

where H[i][i] is the transformed matrix previously described.

The performance monitoring system computes an entropy ADSE value with equation 3:

$$ADSE = {\sum }_{i} {\sum }_{j} P [ i ] [ j ] {log}_{2} ( P [ i ] [ j ] ) \qquad ( 3 )$$

where P[i][j] is the normalized power profile across angular domain i and delay domain j, representing resolvable angular and delay paths. In some implementations, the ADSE value is reported by the UE 102 to the network 104.

ADSE filtering can include the following process for detecting anomalies. The UE 102 can evaluate a difference in ADSE values between two consecutive time points: D(t)=ADSE(t) −ADSE(t−1), . . . ) where: ADSE(t) is the PSE of the current CSI sample, ADSE(t−1) is the PSE of the previous CSI sample, and D(t) captures the temporal change in the smoothness or sparsity of CSI samples. By analyzing the temporal differences in D(t), the UE 102 can detect/identify (410) post deployment model drift events. In some implementations, the performance monitoring system can perform some filtering of the ADSE signal regarding temperature changes over time, to detect spikes or dips (e.g., low pass filtering, etc.). The filter can be represented as D(t)=f(ADSE(t)−ADSE(t−1), . . . ), where f(x) is a filter. The value of D(t) indicates whether the value of ADSE changes over time in a way that implies AI/ML model failure will occur/has occurred. The D(t) filter can be configured to detect any pattern over time that is correlated to AI/ML model failure, drift, etc. For example, the monitoring system can predict trends in the ADSE value, such as a spike in the ADSE indicating that the AI/ML model may no longer be valid. The D(t) value, which takes the ADSE as an input, can be used by the network to proactively employ LCM procedures to maintain the AI/ML model performance in real time or near real time.

Examples of trends that indicate model failure are now described. When a UE transitions from a static to a dynamic environment, there can be a sharp increase in D(t) due to the sudden introduction of environmental effects. The network can initiate LCM actions. In another example, the UE can move from a LOS to an NLOS environment. In this scenario, an obstacle blocks the direct path between the transmitter and receiver. To test or train this process, such a transition can be caused for a UE and value of the ADSE can be observed, which includes a noticeable spike in as the entropy sees due to multipath distributions. The D(t) value can indicate that input distribution has changed, and that the network should perform an LCM operation.

The number of samples for ADSE for computing D(t) can vary. In an example, two samples can be used. In another example, the number of samples can any number, but older samples are exponentially weighted to discount their contributions to zero. This can be represented by D(t)=αD(t−1)+(1−a)ADSE(t).

In some implementations, the UE 102 can use a Long Short-Term Memory (LSTM) network (or other regressor or classifier) for anomaly detection in the temporal domain. LSTM can also be framed under reinforcement learning where the neural network learns to detect anomalies of ADSE temporal variations given real time feedback (based on UE feedback). LSTMs can learn temporal dependencies and capturing trends or patterns in sequential data. The UE 102 can apply the LSTM to analyze power spectral density or path spectral density error temporal variations. The UE 102 can apply reinforcement learning (RL) models, which excel at dynamic, real-time decision-making based on feedback from the environment. The RL models of the UE 102 can adapt to changing conditions, such as UE feedback in a dynamic wireless network, for detection of AI/ML model drift or other anomalies.

In some implementations, the network 104 (or UE 102) can classify different models according to different ADSE metrics. There can be ranges of ADSE that correspond to the a particular AI/ML model. The network determine, based on ADSE values, the best model to be employed is a different one than currently being employed by the UE. Alternatively, the network can initiate retraining procedures based on current conditions to fine tune the AI/ML model.

The UE 102 can perform ADSE evaluation in the following scenarios. For a static to dynamic transition, a UE 102 transitions from a static to a dynamic environment (e.g., moving from indoors to outdoors). A sharp increase in D(t) can occur due to the sudden introduction of mobility and varying multipath effects. For a Line-of-Sight (LOS) to Non-Line-of-Sight (NLOS) transition, an obstacle blocks the direct path between the transmitter and receiver, causing a switch from LOS to NLOS. As a result, a spike may occur in D(t) as the PSE shifts due to altered multipath contributions. The UE 102 can use these metrics to track post deployment drift and model switch. In some implementations, the decision model 416 can be applied by the network 104 based on an ADSE value reported by the UE 102. In some implementations, the UE 102 reports model drift based on ADSE. The decoder 414 of the network 104 can perform (418) ADSE computation for feeding the network based decision model 416.

In some implementations, the decision model 416 can generate a reconstructed CSI signal as received by the UE 102 and send it to a controller 410. The controller 420 (e.g., a module or engine of the network 104) can update the AI/ML model or initiate performance management. For example, the network 104 can initiate inference monitoring with KPIs requiring ground truth measurements, signal to the UE 102 to de-activate the model, signal to the UE to switch to another AI/ML model (based on ADSE proximity), initiate retraining procedures based on current conditions, and/or reconfigure parameters of AI/ML model.

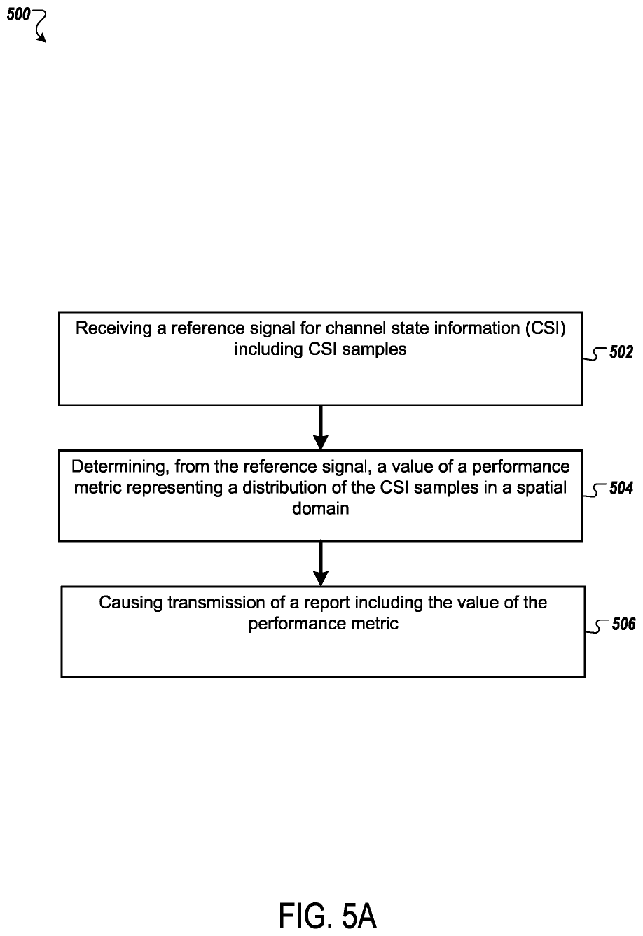

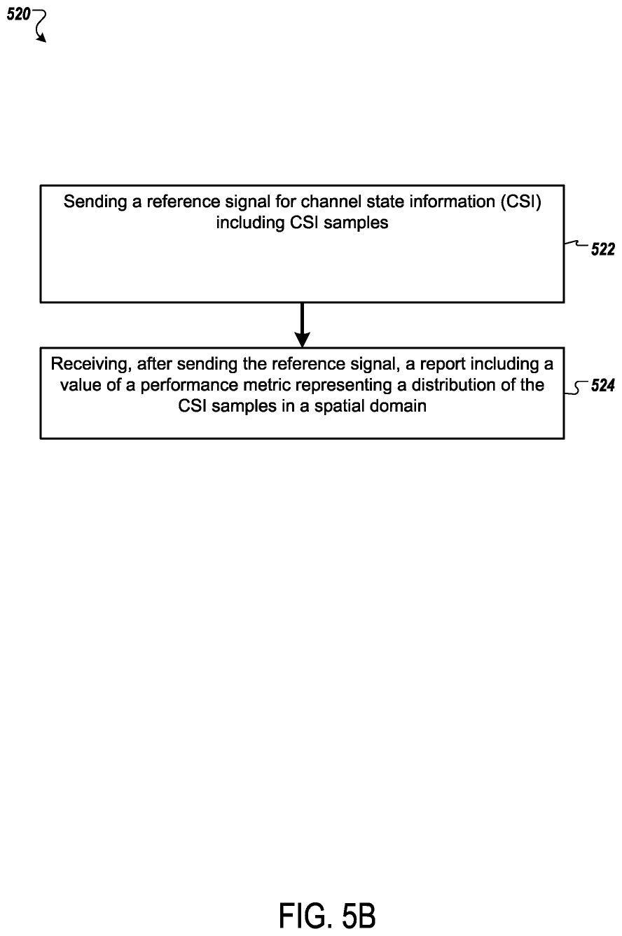

FIG. 5A illustrates a flowchart of an example method 500 for UE-assisted performance monitoring for time-domain downlink beam prediction, according to some implementations. For clarity of presentation, the example method 500 is described in the context of the preceding figures. For clarity of presentation, the example method 500 is described in the context of the preceding figures. For example, the method 500 can be performed by a UE (e.g., the UE 102), or any suitable system, environment, software, hardware, or combination thereof. In some implementations, operations of the method 500 can be run in parallel, in combination, in loops, or in any order. The example method 500 shown in FIG. 5A can be modified or reconfigured to include additional, fewer, or different actions (not shown in FIG. 5A), which can be performed in the order shown or in a different order.

The process 500 includes receiving (502) a reference signal for channel state information (CSI) including CSI samples. The process 500 includes determining (504), from the reference signal, a value of a performance metric representing a distribution of the CSI samples in a spatial domain. In some implementations, determining the value of the performance metric comprises determining a frequency response of a channel across a sub-carrier domain and a spatial transmitter port. In some implementations, the process 500 includes transforming the frequency response into an angular and temporal delay domain matrix resolvable angular paths and delay paths. In some implementations, the process 500 includes determining, from the angular and temporal delay domain matrix, a normalized power profile. In some implementations, the process 500 includes determining the value of the performance metric as a sum of the normalized power profile for each of the angular paths and the delay paths.

The process 500 includes causing (506) transmission of a report including the value of the performance metric. In some implementations, the process 500 includes causing one or more life cycle management (LCM) operations to occur independent of measuring a CSI ground truth value. In some implementations, the process 500 includes updating an AI/ML model configured to predict a beam based on the determined value of the performance metric. In some implementations, the process 500 includes discarding an AI/ML model configured to predict a beam based on the determined value of the performance metric, measuring one or more CSI ground truth values, and causing one or more life cycle management (LCM) operations to occur based on measuring the one or more CSI ground truth values.

In some implementations, the value of a performance metric representing a distribution of the CSI samples in a spatial domain indicates that the CSI samples are more distributed in a spatial-frequency domain when the value is high and less distributed in the spatial-frequency domain when the value is low.

In some implementations, the process 500 includes detecting, based on the value of the performance metric, a drift in an AI/ML model configured to predict beam values.

In some implementations, the process 500 includes determining values of the performance metric over time including the value of the performance metric. In some implementations, the process 500 includes, based on detecting one or more of a trend in the values of the performance metric over time or a sudden change between at least two values of the performance metric over time, causing a life cycle management (LCM) operation to occur.

In some implementations, the process 500 includes determining values of the performance metric over time comprises determining two values of the performance metric. In some implementations, determining values of the performance metric over time comprises determining a set of the performance metric values and reducing a weighting associated with an older value of the performance metric.

In some implementations, the process 500 includes applying a regression model or a classifier model to detect the trend in the values of the performance metric over time or the sudden change between at least two values of the performance metric over time.

In some implementations, the process 500 includes, based on the value of the performance metric, causing one of: initiating inference monitoring with KPIs requiring ground truth measurements; deactivation of an AI/ML model that predicts beams, switching to another AI/ML model that predicts beams, initiating retraining procedures for an AI/ML model based on current channel conditions, or reconfiguring parameters of an AI/ML model.

FIG. 5B illustrates a flowchart of an example method 520 for UE-assisted performance monitoring for time-domain downlink beam prediction, according to some implementations. For clarity of presentation, the example method 520 is described in the context of the preceding figures. For clarity of presentation, the example method 520 is described in the context of the preceding figures. For example, the method 520 can be performed by a base station (e.g., the base station 104), or any suitable system, environment, software, hardware, or combination thereof. In some implementations, operations of the method 520 can be run in parallel, in combination, in loops, or in any order. The example method 520 shown in FIG. 5B can be modified or reconfigured to include additional, fewer, or different actions (not shown in FIG. 5B), which can be performed in the order shown or in a different order.

The process 520 includes sending a reference signal for channel state information (CSI) including CSI samples. The process 520 includes receiving, after sending the reference signal, a report including a value of a performance metric representing a distribution of the CSI samples in a spatial domain.

In some implementations, the value of the performance metric is determined by: determining a frequency response of a channel across a sub-carrier domain and a spatial transmitter port; transforming the frequency response into an angular and temporal delay domain matrix resolvable angular paths and delay paths; determining, from the angular and temporal delay domain matrix, a normalized power profile; and determining the value of the performance metric as a sum of the normalized power profile for each of the angular paths and the delay paths.

In some implementations, thee process 520 includes causing one or more life cycle management (LCM) operations to occur independent of measuring a CSI ground truth value. In some implementations, thee process 520 includes causing an update to an AI/ML model configured to predict a beam based on the value of the performance metric. In some implementations, thee process 520 includes causing an AI/ML model, which is configured to predict a beam, to be discarded based on the value of the performance metric.

In some implementations, the value of a performance metric representing a distribution of the CSI samples in a spatial domain indicates that the CSI samples are more distributed in a spatial-frequency domain when the value is high and less distributed in the spatial-frequency domain when the value is low.

In some implementations, thee process 520 includes detecting, based on the value of the performance metric, a drift in an AI/ML model configured to predict beam values.

In some implementations, thee process 520 includes determining values of the performance metric over time including the value of the performance metric. In some implementations, thee process 520 includes, based on detecting one or more of a trend in the values of the performance metric over time or a sudden change between at least two values of the performance metric over time, causing a life cycle management (LCM) operation to occur.

In some implementations, determining values of the performance metric over time comprises determining two values of the performance metric.

In some implementations, determining values of the performance metric over time comprises determining a set of the performance metric values and reducing a weighting associated with an older value of the performance metric.

In some implementations, thee process 520 includes applying a regression model or a classifier model to detect the trend in the values of the performance metric over time or the sudden change between at least two values of the performance metric over time.

In some implementations, thee process 520 includes, based on the value of the performance metric, causing one of: initiating inference monitoring with KPIs requiring ground truth measurements, deactivation of an AI/ML model that predicts beams, switching to another AI/ML model that predicts beams, initiating retraining procedures for an AI/ML model based on current channel conditions, or reconfiguring parameters of an AI/ML model.

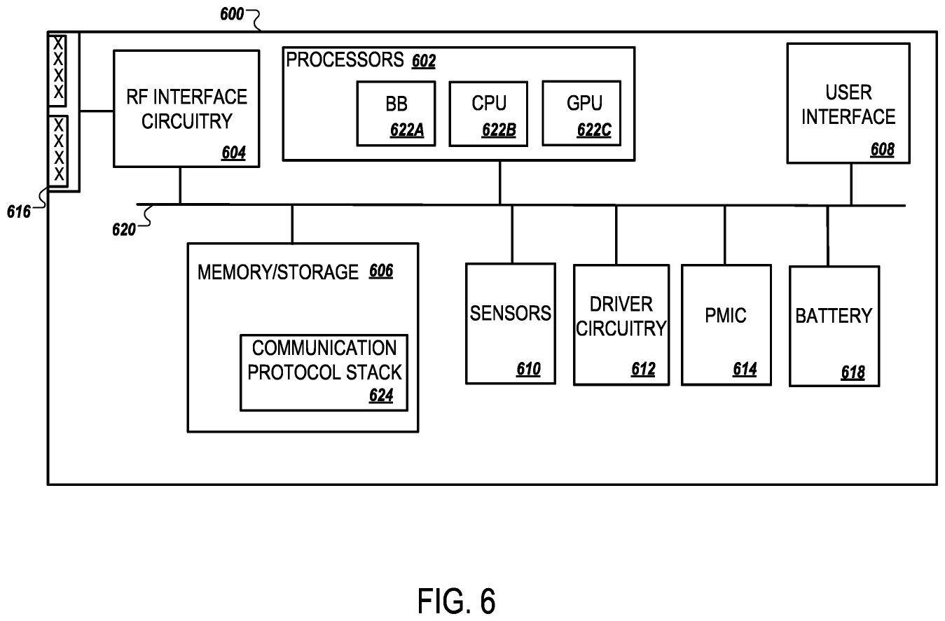

FIG. 6 illustrates an example UE 600. The UE 600 may be similar to and substantially interchangeable with UE 102 of FIG. 1. The UE 600 may be any mobile or non-mobile computing device, such as, for example, a mobile phone, computer, tablet, industrial wireless sensors, video device (for example, cameras, video cameras, etc.), wearable devices (for example, a smart watch), relaxed-IoT devices, etc.

The UE 600 may include any/all of processor 602, RF interface circuitry 604, memory/storage 606, user interface 608, sensors 610, driver circuitry 612, power management integrated circuit (PMIC) 614, one or more antenna(s) 616, and battery 618. The components of the UE 600 may be implemented as integrated circuits (ICs), portions thereof, discrete electronic devices, or other modules, logic, hardware, software, firmware, or a combination thereof. The block diagram of FIG. 6 is intended to show a high-level view of some of the components of the UE 600. However, some of the components shown may be omitted, additional components may be present, and a different arrangement of the components shown may occur in other implementations.

The components of the UE 600 may be coupled with various other components over one or more interconnects 620, which may represent any type of interface, input/output, bus (local, system, or expansion), transmission line, trace, optical connection, etc., that allows various circuit components (on common or different chips or chipsets) to interact with one another.

The processor 602 may include one or more processors. For example, the processor 602 may include processor circuitry such as, for example, baseband processor circuitry (BB) 622A, central processor unit circuitry (CPU) 622B, and graphics processor unit circuitry (GPU) 622C. The processor 602 may include any type of circuitry or processor circuitry that executes or otherwise operates computer-executable instructions, such as program code, software modules, or functional processes from memory/storage 606 to cause the UE 600 to perform operations as described herein.

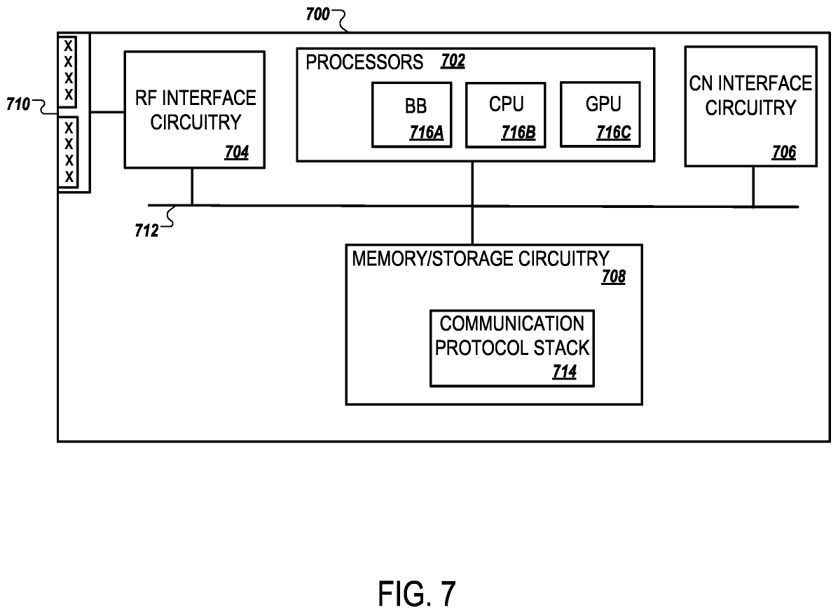

The processor 602 can be configured to receive a reference signal for channel state information (CSI) including CSI samples. The process 602 can determine, from the reference signal, a value of a performance metric representing a distribution of the CSI samples in a spatial domain; such as the ADSE performance metric previously described. The processor 602 can cause transmission of a report including the value of the performance metric. The report can indicate changes to values of the performance metric over time. The report, which can be sent to the network (such as the base station 700 of FIG. 7), may cause the network to detect one or more of a trend in the values of the performance metric over time or a sudden change between at least two values of the performance metric over time. The network 700 or in some examples, the processor 602, can cause a life cycle management (LCM) operation to occur in which the AI/ML model of the UE is changed, dropped, or otherwise adjusted. The processor 602 may cause the LCM operations after applying a regression model or a classifier model to detect a trend in the values of the performance metric over time or a sudden change between at least two values of the performance metric over time.

The processor 602 can determine the value of the performance metric, such as the ADSE metric, by determining a frequency response of a channel across a sub-carrier domain and a spatial transmitter port. The processor 602 transforms the frequency response into an angular and temporal delay domain matrix resolvable angular paths and delay paths. The processor 602 determines, from the angular and temporal delay domain matrix, a normalized power profile. The processor 602 determines the value of the performance metric as a sum of the normalized power profile for each of the angular paths and the delay paths. The processor 602 can cause an adjustment to the AL/ML model or another LCM operation without performing a CSI ground truth measurement or reporting it, saving signaling overhead.

The processor 602 determines a value of the performance metric that represents a distribution of the CSI samples in a spatial domain. A higher value indicates that the CSI samples are more distributed in a spatial-frequency domain. A lower value indicates that the CSI samples are less distributed in the spatial-frequency domain. The processor 602 can detect a drift in the AI/ML model of the UE 600 based on the value of the performance metric, a drift in an AI/ML model configured to predict beam values. Based on the value of the performance metric, the processor 602 can cause at least one of: initiating inference monitoring with KPIs requiring ground truth measurements, deactivation of an AI/ML model that predicts beams, switching to another AI/ML model that predicts beams, initiating retraining procedures for an AI/ML model based on current channel conditions, or reconfiguring parameters of an AI/ML model.

In some implementations, the baseband processor circuitry 622A may access a communication protocol stack 624 in the memory/storage 606 to communicate over a 3GPP compatible network. In general, the baseband processor circuitry 622A may access the communication protocol stack to perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 604. The baseband processor circuitry 622A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 606 may include one or more non-transitory, computer-readable media that includes instructions (for example, communication protocol stack 624) that may be executed by the processor 602 to cause the UE 600 to perform various operations described herein. The memory/storage 606 include any type of volatile or non-volatile memory that may be distributed throughout the UE 600. In some implementations, some of the memory/storage 606 may be located on the processor 602 itself (for example, L1 and L2 cache), while other memory/storage 606 is external to the processor 602 but accessible thereto via a memory interface. The memory/storage 606 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 604 may include transceiver circuitry and radio frequency front module (RFEM) that allows the UE 600 to communicate with other devices over a radio access network. The RF interface circuitry 604 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 616 and proceed to filter and amplify (with a low-noise amplifier) the signal. The signal may be provided to a receiver of the transceiver that downconverts the RF signal into a baseband signal that is provided to the baseband processor.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 616. In various implementations, the RF interface circuitry 604 may be configured to transmit/receive signals in a manner compatible with NR access technologies.

The antenna(s) 616 may include one or more antenna elements to convert electrical signals into radio waves to travel through the air and to convert received radio waves over the air into electrical signals. In some implementations, the antenna elements may be arranged into one or more antenna panels. The antenna(s) 616 may have antenna panels that are omnidirectional, directional, or a combination thereof, to enable beamforming and multiple input, multiple output communications. The antenna(s) 616 may include any/all of microstrip antennas, printed antennas fabricated on the surface of one or more printed circuit boards, patch antennas, phased array antennas, etc. The antenna(s) 616 may have one or more panels designed for one or more specific frequency bands, such as bands in FR1 or FR2.

The user interface 608 includes various input/output (I/O) devices designed to enable user interaction with the UE 600. The user interface 608 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 600.

The sensors 610 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 612 may include software and hardware elements that operate to control particular devices that are embedded in the UE 600, attached to the UE 600, or otherwise communicatively coupled with the UE 600. The driver circuitry 612 may include individual drivers allowing other components to interact with or control various input/output (I/O) devices that may be present within, or connected to, the UE 600. For example, driver circuitry 612 may include a display driver to control and allow access to a display device, a touchscreen driver to control and allow access to a touchscreen interface, sensor drivers to obtain sensor readings of sensors 610 and control and allow access to sensors 610, drivers to obtain actuator positions of electro-mechanic components or control and allow access to the electro-mechanic components, a camera driver to control and allow access to an embedded image capture device, audio drivers to control and allow access to one or more audio devices.

The PMIC 614 may manage power provided to various components of the UE 600. In particular, with respect to the processor 602, the PMIC 614 may control power-source selection, voltage scaling, battery charging, or DC-to-DC conversion.

In some implementations, the PMIC 614 may control, or otherwise be part of, various power saving mechanisms of the UE 600. A battery 618 may power the UE 600, although in some examples the UE 600 may be mounted deployed in a fixed location and may have a power supply coupled to an electrical grid. The battery 618 may be a lithium ion battery, a metal-air battery, such as a zinc-air battery, an aluminum-air battery, a lithium-air battery, and the like. In some implementations, such as in vehicle-based applications, the battery 618 may be a typical lead-acid automotive battery.

FIG. 7 illustrates an example access node 700 (e.g., a base station or gNB), according to some implementations. The access node 700 may be similar to and substantially interchangeable with base station 104. The access node 700 may include one or more of processor 702, RF interface circuitry 704, core network (CN) interface circuitry 706, memory/storage circuitry 708, and one or more antenna(s) 710. The processor 702 may include any type of circuitry or processor circuitry that executes or otherwise operates computer-executable instructions, such as program code, software modules, or functional processes from memory/storage circuitry 708 to cause the access node 700 to perform operations as described herein.

The components of the access node 700 may be coupled with various other components over one or more interconnects 712. The processor 702, RF interface circuitry 704, memory/storage circuitry 708 (including communication protocol stack 714), antenna(s) 710, and interconnects 712 may be similar to like-named elements shown and described with respect to FIG. 6. For example, the processor 702 may include processor circuitry such as, for example, baseband processor circuitry (BB) 716A, central processor unit circuitry (CPU) 716B, and graphics processor unit circuitry (GPU) 716C.

The processor 702 of the access node 700 is configured to send a reference signal for channel state information (CSI) including CSI samples to a UE, such as UE 600 of FIG. 6. The processor 702 can receive, after sending the reference signal, a report including a value of a performance metric representing a distribution of the CSI samples in a spatial domain. The processor 702 can instruct the UE to change parameters of its AI/ML beam prediction model, drop the AI/ML model, switch to a different AI/ML model, or perform another LCM operation described herein when the performance metric value changes or a particular trend in the value is detected. The processor 702 can cause the LCM operation to occur without (independent of) measuring a CSI ground truth value.

The value of the performance metric represents a distribution of the CSI samples in a spatial domain. The CSI samples are more distributed in a spatial-frequency domain when the value is high and less distributed in the spatial-frequency domain when the value is low.

Based on the value of the performance metric, the processor 702 can detect a drift in the UE's 600 AI/ML model configured to predict beam values. The processor 702 can monitor values of the performance metric over time and detect a trend in the values of the performance metric over time or a sudden change between at least two values of the performance metric over time. The processor 702 can initiate an LCM operation to occur when the trend or change in values is detected.

The CN interface circuitry 706 may provide connectivity to a core network, for example, a 5th Generation Core network (5GC) using a 5GC-compatible network interface protocol such as carrier Ethernet protocols, or some other suitable protocol. Network connectivity may be provided to/from the access node 700 via a fiber optic or wireless backhaul. The CN interface circuitry 706 may include one or more dedicated processors or FPGAs to communicate using one or more of the aforementioned protocols. In some implementations, the CN interface circuitry 706 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 700 that operates in an NR or 5G system (for example, a gNB), and the term “E-UTRAN node” or the like may refer to an access node 700 that operates in an LTE or 4G system (e.g., an eNB). According to various implementations, the access node 700 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 700 may be implemented as one or more software entities running on server computers as part of a virtual network, which may be referred to as a CRAN and/or a virtual baseband unit pool (vBBUP). In V2X scenarios, the access node 700 may be or act as a “Roadside Unit.” The term “Roadside Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc., as described above in connection with one or more of the preceding figures may be configured to operate in accordance with one or more of the examples set forth below in the example section.

Some embodiments described herein can include use of learning and/or non-learning-based process(es). The use can include collecting, pre-processing, encoding, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML beam prediction processes can be used to benefit users.

For example, the data can be used to train models that can be deployed to improve performance, accuracy, and/or functionality of applications and/or services. Accordingly, the use of the data enables the AI/ML beam prediction processes to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in AI/ML beam prediction processes are also contemplated by the present disclosure.

The present disclosure contemplates that, in some embodiments, data used by AI/ML beam prediction processes includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML beam prediction processes, should attempt to comply with well-established privacy policies and/or privacy practices.

### Examples

Example 1 includes a method for wireless communication including receiving a reference signal for channel state information (CSI) including CSI samples, determining, from the reference signal, a value of a performance metric representing a distribution of the CSI samples in a spatial domain, and causing transmission of a report including the value of the performance metric.

Example 2 includes the method of example 1, wherein determining the value of the performance metric comprises determining a frequency response of a channel across a sub-carrier domain and a spatial transmitter port, transforming the frequency response into an angular and temporal delay domain matrix resolvable angular paths and delay paths, determining, from the angular and temporal delay domain matrix, a normalized power profile, and determining the value of the performance metric as a sum of the normalized power profile for each of the angular paths and the delay paths.

Example 3 includes the method of any of examples 1 to 2, the method further including causing one or more life cycle management (LCM) operations to occur independent of measuring a CSI ground truth value.

Example 4 includes the method of any of examples 1 to 3, further including updating an AI/ML model configured to predict a beam based on the determined value of the performance metric.

Example 5 includes the method of any of examples 1 to 4, further including discarding an AI/ML model configured to predict a beam based on the determined value of the performance metric; measuring one or more CSI ground truth values; and causing one or more life cycle management (LCM) operations to occur based on measuring the one or more CSI ground truth values.

Example 6 includes the method of any of examples 1 to 5, wherein the value of a performance metric representing a distribution of the CSI samples in a spatial domain indicates that the CSI samples are more distributed in a spatial-frequency domain when the value is high and less distributed in the spatial-frequency domain when the value is low.

Example 7 includes the method of any of examples 1 to 6, further including detecting, based on the value of the performance metric, a drift in an AI/ML model configured to predict beam values.

Example 8 includes the method of any of examples 1 to 7, further including determining values of the performance metric over time including the value of the performance metric; and based on detecting one or more of a trend in the values of the performance metric over time or a sudden change between at least two values of the performance metric over time, causing a life cycle management (LCM) operation to occur.

Example 9 includes the method of example 8, further including, wherein determining values of the performance metric over time comprises determining two values of the performance metric.

Example 10 includes the method of example 8, wherein determining values of the performance metric over time comprises determining a set of the performance metric values and reducing a weighting associated with an older value of the performance metric.

Example 11 includes the method of example 8, further including applying a regression model or a classifier model to detect the trend in the values of the performance metric over time or the sudden change between at least two values of the performance metric over time.

Example 12 includes the method of any of examples 1 to 11, the method further including, based on the value of the performance metric, causing at least one of: initiating inference monitoring with KPIs requiring ground truth measurements, deactivation of an AI/ML model that predicts beams, switching to another AI/ML model that predicts beams, initiating retraining procedures for an AI/ML model based on current channel conditions, or reconfiguring parameters of an AI/ML model.

Example 13 includes sending a reference signal for channel state information (CSI) including CSI samples; and receiving, after sending the reference signal, a report including a value of a performance metric representing a distribution of the CSI samples in a spatial domain.

Example 14 includes the method of example 13, wherein the value of the performance metric is determined by: determining a frequency response of a channel across a sub-carrier domain and a spatial transmitter port; transforming the frequency response into an angular and temporal delay domain matrix resolvable angular paths and delay paths; determining, from the angular and temporal delay domain matrix, a normalized power profile; and determining the value of the performance metric as a sum of the normalized power profile for each of the angular paths and the delay paths.

Example 15 includes the method of any of examples 13 to 14, further including causing one or more life cycle management (LCM) operations to occur independent of measuring a CSI ground truth value.

Example 16 includes the method of any of examples 13 to 15, further including causing an update to an AI/ML model configured to predict a beam based on the value of the performance metric.

Example 17 includes the method of any of examples 13 to 16, further including causing an AI/ML model, which is configured to predict a beam, to be discarded based on the value of the performance metric.

Example 18 includes the method of any of examples 13 to 17, further including, wherein the value of a performance metric representing a distribution of the CSI samples in a spatial domain indicates that the CSI samples are more distributed in a spatial-frequency domain when the value is high and less distributed in the spatial-frequency domain when the value is low.

Example 19 includes the method of any of examples 13 to 18, further including: detecting, based on the value of the performance metric, a drift in an AI/ML model configured to predict beam values.

Example 20 includes the method of any of examples 13 to 19, further including determining values of the performance metric over time including the value of the performance metric; and based on detecting one or more of a trend in the values of the performance metric over time or a sudden change between at least two values of the performance metric over time, causing a life cycle management (LCM) operation to occur.

Example 21 includes the method of example 20, wherein determining values of the performance metric over time comprises determining two values of the performance metric.

Example 22 includes the method of example 20, wherein determining values of the performance metric over time comprises determining a set of the performance metric values and reducing a weighting associated with an older value of the performance metric.

Example 22 includes the method of example 20, further including applying a regression model or a classifier model to detect the trend in the values of the performance metric over time or the sudden change between at least two values of the performance metric over time.

Example 23 includes the method of any of examples 13 to 22, further including, based on the value of the performance metric, causing at least one of: initiating inference monitoring with KPIs requiring ground truth measurements, deactivation of an AI/ML model that predicts beams, switching to another AI/ML model that predicts beams, initiating retraining procedures for an AI/ML model based on current channel conditions, or reconfiguring parameters of an AI/ML model.

Example 24 includes one or more processors configured to, when executing instructions stored in memory, perform the method of any of examples 1 to 23.

Example 25 includes a non-transitory computer storage medium encoded with instructions that, when executed by one or more processors, cause the one or more processors to perform the method perform the method of any of examples 1 to 23.

Example 26 includes a system comprising one or more processors and one or more storage devices on which are stored instructions that are operable, when executed by the one or more processors, to cause the one or more processors to perform the method of any of examples 1 to 23.

Example 27 includes an apparatus comprising one or more baseband processors configured to perform the method of any of examples 1 to 23.

Example 28 includes a base station comprising one or more processors configured to perform the method of any of examples 13 to 24.

What is claimed is:

1. A method, comprising:
receiving a reference signal for one or more channel state information (CSI) samples;
determining, from the reference signal, a value of a performance metric representing a distribution of the one or more CSI samples in a spatial domain; and
causing transmission of a report including the value of the performance metric.

2. The method of claim 1, wherein determining the value of the performance metric comprises:
determining a frequency response of a channel across a sub-carrier domain and a spatial transmitter port;
transforming the frequency response into an angular and temporal delay domain matrix resolvable angular paths and delay paths;
determining, from the angular and temporal delay domain matrix, a normalized power profile; and
determining the value of the performance metric as a sum of the normalized power profile for each of the angular paths and the delay paths.

3. The method of claim 1, further comprising:
causing one or more life cycle management (LCM) operations to occur independent of measuring a CSI ground truth value.

4. The method of claim 1, further comprising:
updating an AI/ML model configured to predict a beam based on the determined value of the performance metric.

5. The method of claim 1, further comprising:
discarding an AI/ML model configured to predict a beam based on the determined value of the performance metric;
measuring one or more CSI ground truth values; and
causing one or more life cycle management (LCM) operations to occur based on measuring the one or more CSI ground truth values.

6. The method of claim 1, wherein the value of a performance metric representing a distribution of the one or more CSI samples in a spatial domain indicates that the one or more CSI samples are more distributed in a spatial-frequency domain when the value is high and less distributed in the spatial-frequency domain when the value is low.

7. The method of claim 1, further comprising:
detecting, based on the value of the performance metric, a drift in an AI/ML model configured to predict beam values.

8. The method of claim 1, further comprising:
determining values of the performance metric over time including the value of the performance metric; and
based on detecting one or more of a trend in the values of the performance metric over time or a sudden change between at least two values of the performance metric over time, causing a life cycle management (LCM) operation to occur.

9. The method of claim 1, further comprising:
based on the value of the performance metric, causing at least one of:
initiating inference monitoring with KPIs requiring ground truth measurements,
deactivation of an AI/MVL model that predicts beams,
switching to another AI/ML model that predicts beams,
initiating retraining procedures for an AI/ML model based on current channel conditions, or
reconfiguring parameters of an AI/ML model.

10. One or more processors configured to, when executing instructions stored in memory, perform operations comprising:
sending a reference signal for one or more channel state information (CSI) samples; and
receiving, after sending the reference signal, a report including a value of a performance metric representing a distribution of the one or more CSI samples in a spatial domain.

11. The one or more processors of claim 10, wherein the value of the performance metric is determined by:
determining a frequency response of a channel across a sub-carrier domain and a spatial transmitter port;
transforming the frequency response into an angular and temporal delay domain matrix resolvable angular paths and delay paths;
determining, from the angular and temporal delay domain matrix, a normalized power profile; and
determining the value of the performance metric as a sum of the normalized power profile for each of the angular paths and the delay paths.

12. The one or more processors of claim 10, the operations further comprising:
causing one or more life cycle management (LCM) operations to occur independent of measuring a CSI ground truth value.

13. The one or more processors of claim 10, the operations further comprising:
causing an update to an AI/ML model configured to predict a beam based on the value of the performance metric.

14. The one or more processors of claim 10, the operations further comprising:
causing an AI/ML model, which is configured to predict a beam, to be discarded based on the value of the performance metric.

15. The one or more processors of claim 10, the operations further comprising:
detecting, based on the value of the performance metric, a drift in an AI/ML model configured to predict beam values.

16. The one or more processors of claim 10, the operations further comprising:
determining values of the performance metric over time including the value of the performance metric; and
based on detecting one or more of a trend in the values of the performance metric over time or a sudden change between at least two values of the performance metric over time, causing a life cycle management (LCM) operation to occur.

17. The one or more processors of claim 10, the operations further comprising:
based on the value of the performance metric, causing at least one of:
initiating inference monitoring with KPIs requiring ground truth measurements,
deactivation of an AI/IL model that predicts beams,
switching to another AI/ML model that predicts beams,
initiating retraining procedures for an AI/ML model based on current channel conditions, or
reconfiguring parameters of an AI/ML model.

18. An apparatus comprising one or more baseband processors configured to perform operations comprising:
receiving a reference signal for one or more channel state information (CSI) samples;
determining, from the reference signal, a value of a performance metric representing a distribution of the one or more CSI samples in a spatial domain; and
causing transmission of a report including the value of the performance metric.

19. The apparatus of claim 18, the operations further comprising:
causing one or more life cycle management (LCM) operations to occur independent of measuring a CSI ground truth value.

20. The apparatus of claim 18, the operations further comprising:
discarding an AI/ML model configured to predict a beam based on the determined value of the performance metric; and
measuring one or more CSI ground truth values; and
causing one or more life cycle management (LCM) operations to occur based on measuring the one or more CSI ground truth values.
